(19) United States
(12) Patent Application Publication
(10) Pub. No.: US 2020/0273485 A1
(43) Pub. Date: Aug. 27, 2020

(54) USER ENGAGEMENT DETECTION

(71) Applicant: Synaptics Incorporated, San Jose, CA (US)

(72) Inventors: Adil Ilyas Jagmag, Hollis, NH (US); Utkarsh Gaur, Millbrae, CA (US); Gaurav Arora, Cupertino, CA (US)

(21) Appl. No.: 16/799,263

(22) Filed: Feb. 24, 2020

Related U.S. Application Data
(60) Provisional application No. 62/809,507, filed on Feb. 22, 2019.

(51) Int. Cl. G10L 25/63; G10L 25/30; G10L 17/26; G06N 3/04; G06Q 30/02; G06Q 30/06; H04N 21/81

(52) U.S. Cl. CPC G10L 25/63; G10L 25/30; G10L 17/26; H04N 21/812; G06Q 30/0242; G06Q 30/0631; G06N 3/0472

(57) ABSTRACT

A method and apparatus for user engagement detection. A media device captures sensor data via one or more sensors while concurrently playing back a first content item. The media device detects one or more reactions to the first content item by one or more users based at least in part on the sensor data and controls a media playback interface used to play back the first content item based at least in part on the detected reactions.

### CROSS-REFERENCE TO RELATED APPLICATION

This application claims priority and benefit under 35 USC § 119(e) to U.S. Provisional Patent Application No. 62/809,507, filed Feb. 22, 2019, which is incorporated herein by reference in its entirety.

### TECHNICAL FIELD

The present embodiments relate generally to media content, and specifically to detecting user engagement when playing back media content.

### BACKGROUND OF RELATED ART

Machine learning is a technique for improving the ability of a computer system or application to perform a certain task. Machine learning can be broken down into two component parts: training and inferencing. During the training phase, a machine learning system is provided with an “answer” and a large volume of raw data associated with the answer. For example, a machine learning system may be trained to recognize cats by providing the system with a large number of cat photos and/or videos (e.g., the raw data) and an indication that the provided media contains a “cat” (e.g., the answer). The machine learning system may then analyze the raw data to “learn” a set of rules that can be used to describe the answer. For example, the system may perform statistical analysis on the raw data to determine a common set of features (e.g., the rules) that can be associated with the term “cat” (e.g., whiskers, paws, fur, four legs, etc.). During the inferencing phase, the machine learning system may apply the rules to new data to generate answers or inferences about the data. For example, the system may analyze a family photo and determine, based on the learned rules, that the photo includes an image of a cat.

### SUMMARY

This Summary is provided to introduce in a simplified form a selection of concepts that are further described below in the Detailed Description. This Summary is not intended to identify key features or essential features of the claims subject matter, nor is it intended to limit the scope of the claimed subject matter.

A method and apparatus for user engagement detection is disclosed. One innovative aspect of the subject matter of this disclosure can be implemented in a method of playing back media content. In some embodiments, the method may include steps of capturing sensor data via one or more sensors while concurrently playing back a first content item; detecting one or more reactions to the first content item by one or more users based at least in part on the sensor data; and controlling a media playback interface used to play back the first content item based at least in part on the detected reactions.

### BRIEF DESCRIPTION OF THE DRAWINGS

The present embodiments are illustrated by way of example and are not intended to be limited by the figures of the accompanying drawings.

FIG. 1 shows a block diagram of a machine learning system, in accordance with some embodiments.

FIG. 2 shows an example environment in which the present embodiments may be implemented.

FIG. 3 shows a block diagram of a media device, in accordance with some embodiments.

FIG. 4 shows a block diagram of a reaction detection circuit, in accordance with some embodiments.

FIG. 5 shows an example neural network architecture that can be used for generating inferences about user reaction, in accordance with some embodiments.

FIG. 6 shows another block diagram of a media device, in accordance with some embodiments.

FIG. 7 shows an illustrative flowchart depicting an example operation for playing back media content, in accordance with some embodiments.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the aspects of the disclosure. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory. The interconnection between circuit elements or software blocks may be shown as buses or as single signal lines. Each of the buses may alternatively be a single signal line, and each of the single signal lines may alternatively be buses, and a single line or bus may represent any one or more of a myriad of physical or logical mechanisms for communication between components.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory computer-readable storage medium comprising instructions that, when executed, performs one or more of the methods described above. The non-transitory computer-readable storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors. The term “processor,” as used herein, may refer to any general-purpose processor, conventional processor, controller, microcontroller, and/or state machine capable of executing scripts or instructions of one or more software programs stored in memory. The term “media device,” as used herein, may refer to any device capable of providing an adaptive and personalized user experience. Examples of media devices may include, but are not limited to, personal computing devices (e.g., desktop computers, laptop computers, netbook computers, tablets, web browsers, e-book readers, and personal digital assistants (PDAs)), data input devices (e.g., remote controls and mice), data output devices (e.g., display screens and printers), remote terminals, kiosks, video game machines (e.g., video game consoles, portable gaming devices, and the like), communication devices (e.g., cellular phones such as smart phones), media devices (e.g., recorders, editors, and players such as televisions, set-top boxes, music players, digital photo frames, and digital cameras), and the like.

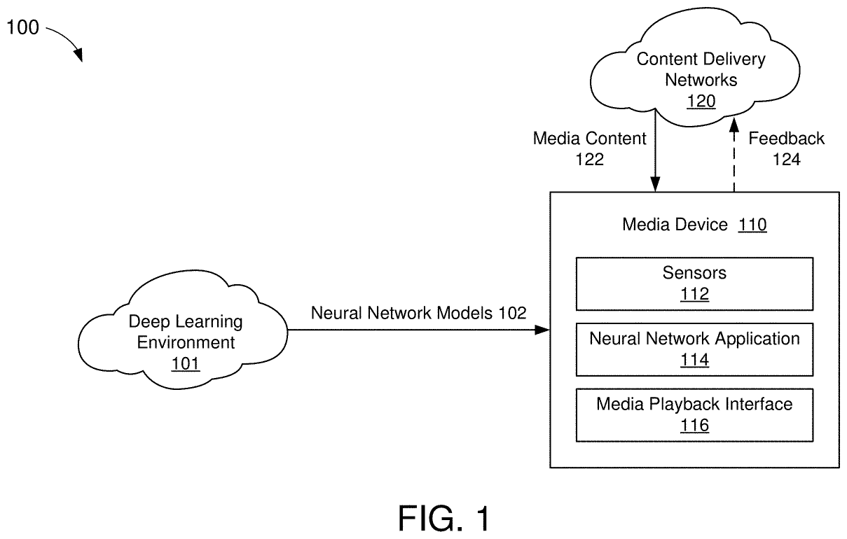

FIG. 1 shows a block diagram of a machine learning system 100, in accordance with some embodiments. The system 100 includes a deep learning environment 101 and a media device 110. The deep learning environment 101 may include memory and/or processing resources to generate or train one or more neural network models 102. In some embodiments, the neural network models 102 may be stored and/or implemented (e.g., used for inferencing) on the media device 110. For example, the media device 110 may use the neural network models 102 to determine a user's level of engagement and/or reaction towards media content that may be rendered or played back by the media device 110.

The media device 110 may be any device capable of capturing, storing, and/or playing back media content. Example media devices include set-top boxes (STBs), computers, mobile phones, tablets, televisions (TVs) and the like. The media device 110 may include content memory (not shown for simplicity) to store or buffer media content (e.g., images, video, audio recordings, and the like) for playback and/or display on the media device 110 or a display device (not shown for simplicity) coupled to the media device 110. In some embodiments, the media device 110 may receive media content 122 from one or more content delivery networks (CDNs) 120. For example, the media content 122 may include television shows, movies, and/or other media content created by a third-party content creator or provider (e.g., television network, production studio, streaming service, and the like). In some aspects, the media content 122 may be requested by, and provided (e.g., streamed) to, the media device 110 in an on-demand manner.

In some implementations, the media device 110 may receive feedback from the user indicating the user's level of interest (or disinterest) in one or more content items being played back by the media device 110. Conventional feedback mechanisms rely on manual user input. For example, after viewing a particular content item, the user may be prompted to provide a rating for that content item using an input device (e.g., mouse, keyboard, touchscreen, and the like). Example ratings may include, but are not limited to, a star rating, a “like” or “dislike” selection, a thumbs-up or thumbs-down selection, or any other pre-defined metric that may be used to gauge the user's interest in the media content. However, because such rating systems require an additional level of user interaction, many users choose to forgo the ratings altogether (especially if the user did not enjoy the content enough to watch it in its entirety).

Moreover, when multiple users are viewing a particular content item from the same media device, such ratings may not provide an accurate measure of which (if any) viewers liked or disliked the content item or what about the content item the users liked or disliked. For example, a conventional rating system may only indicate how one user in the group felt about the content item or how the entire group felt as a whole (e.g., on average) about the content item. It may not be able to indicate how each individual user felt about the content item. Furthermore, a conventional rating system may only indicate a user's overall rating of the content item (e.g., in its entirety). It may not be able to indicate how individual users felt towards individual portions (e.g., scenes) of the content item.

Aspects of the present disclosure recognize that a user's reaction and/or level of engagement may be determined based on visual, audio, and/or other biometric cues about the user. For example, if the user is actively engaged or interested in the content being displayed, the user may exhibit certain physical or emotional cues including (but not limited to): gazing or focusing on the display screen, leaning forward in the seat, expressive facial features (e.g., laughter, shock, excitement, etc.), elevated heart rate, silence, or expressive phrases (e.g., “wow,” “oh my gosh,” expletives, etc.). On the other hand, if the user is disengaged or disinterested in the content being displayed, the user may exhibit other physical or emotional cues including (but not limited to): looking away from the display screen, leaning back in the seat, inexpressive facial features (e.g., dull, deadpan, expressionless, etc.), low or steady heart rate, leaving the viewing environment, or conversing with other people (e.g., in the viewing environment, on the phone, in another room, etc.).

Thus, in some embodiments, the media device 110 may dynamically detect a user's reaction and/or level of engagement towards media content by sensing one or more visual, audio, or other biometric cues. The media device 110 may include one or more sensors 112, a neural network application 114, and a media playback interface 116. The sensors 112 may be configured to receive user inputs and/or collect data (e.g., images, video, audio recordings, biometric information, and the like) about the user and/or the surrounding environment. Example suitable sensors include (but are not limited to): cameras, microphones, capacitive sensors, biometric sensors, and the like. The neural network application 114 may be configured to generate one or more inferences about the data collected from the sensors 112. For example, in some aspects, the neural network application 114 may analyze the sensor data to infer a reaction or engagement level of the user when viewing a particular content item (e.g., to determine whether the user liked or disliked the content).

The media device 110 may use neural network models 102 to detect and/or identify one or more reactions and/or engagement levels from the data collected from the sensors 112. In some aspects, the neural network models 102 may be trained to detect one or more pre-defined reactions and/or indications of user engagement. For example, an interested or engaged user may be gazing or focusing on the display screen, leaning forward in the seat, displaying expressive facial features, exhibiting elevated heart rates, watching in silence, or vocalizing expressive phrases. On the other hand, a disinterested or disengaged user may be looking away from the display screen, leaning back in the seat, displaying inexpressive facial features, exhibiting low or steady heart rates, leaving the viewing environment, or conversing with other people. The neural network models 122 may be trained on a large dataset of pre-identified user reactions to recognize the various elements and/or characteristics that uniquely define different types of user reactions or levels of engagement.

The deep learning environment 101 may be configured to generate the neural network models 102 through deep learning. Deep learning is a particular form of machine learning in which the training phase is performed over multiple layers, generating a more abstract set of rules in each successive layer. Deep learning architectures are often referred to as artificial neural networks due to the way in which information is processed (e.g., similar to a biological nervous system). For example, each layer of the deep learning architecture may be composed of a number of artificial neurons. The neurons may be interconnected across the various layers so that input data (e.g., the raw data) may be passed from one layer to another. More specifically, each layer of neurons may perform a different type of transformation on the input data that will ultimately result in a desired output (e.g., the answer). The interconnected framework of neurons may be referred to as a neural network model. Thus, the neural network models 102 may include a set of rules that can be used to describe a particular type of emotion (e.g., shock, horror, sadness, joy, excitement, and the like) and/or quantize the user's level of engagement (e.g., interested, slightly interested, very interested, disinterested, and the like).

The deep learning environment 101 may have access to a large volume of raw data and may be trained to recognize a set of rules (e.g., certain objects, features, a quality of service, such as a quality of a received signal or pixel data, and/or other detectable attributes) associated with the raw data. For example, in some aspects, the deep learning environment 101 may be trained to recognize an engaged user. During the training phase, the deep learning environment 101 may process or analyze a large number of images, videos, audio, and/or other biometric data captured from an “engaged” user. The deep learning environment 101 may also receive an indication that the provided data describes an engaged user (e.g., in the form of user input from a user or operator reviewing the media and/or data or metadata provided with the media). The deep learning environment 101 may then perform statistical analysis on the images, videos, audio, and/or other biometric data to determine a common set of features associated with engaged users. In some aspects, the determined features (or rules) may form an artificial neural network spanning multiple layers of abstraction.

The deep learning environment 101 may provide the learned set of rules (e.g., as the neural network models 102) to the media device 110 for inferencing. It is noted that, when detecting a user's reaction to live or streaming media on an embedded device, it may be desirable to reduce the inferencing time and/or size of the neural network. For example, fast inferencing may be preferred (e.g., at the cost of accuracy) when detecting user reactions in real-time. Thus, in some aspects, the neural network models 102 may comprise compact neural network architectures (including deep neural network architectures) that are more suitable for inferencing on embedded devices.

In some aspects, one or more of the neural network models 102 may be provided to (e.g., and stored on) the media device 110 at a device manufacturing stage. For example, the media device 110 may be pre-loaded with the neural network models 102 prior to being shipped to an end user. In some other aspects, the media device 110 may receive one or more of the neural network models 102 from the deep learning environment 101 at runtime. For example, the deep learning environment 101 may be communicatively coupled to the media device 110 via a network (e.g., the cloud). Accordingly, the media device 110 may receive the neural network models 102 (including updated neural network models) from the deep learning environment 101, over the network, at any time.

In some embodiments, the neural network application 114 may generate the inferences based on the neural network models 102 provided by the deep learning environment 101. For example, during the inferencing phase, the neural network application 114 may apply the neural network models 102 to the data collected from the sensors 112, by traversing the artificial neurons in the artificial neural network, to generate inferences about a user's reactions or levels of engagement level toward certain media content 122. In some embodiments, the neural network application 114 may further store the inferences (e.g., reaction mappings) along with the media content 122 in a content memory (not shown for simplicity). It is noted that, by generating the inferences locally on the media device 110, the present embodiments may be used to perform machine learning on media content in a manner that protects user privacy and/or the rights of content providers.

In some embodiments, the neural network application 114 may use the data collected from the sensors 112 to perform additional training on the neural network models 102. For example, the neural network application 114 may refine the neural network models 102 and/or generate new neural network models based on the locally-generated sensor data. In some aspects, the neural network models 102 may be fine-tuned to detect and/or recognize particular users' reactions. For example, such additional training may be performed based on personal content (such as home videos, photos, or audio recordings) stored on, or otherwise accessible by, the media device 110. The additional training may be initiated manually (e.g., using an independent scripted mechanism) or automatically upon detecting the personal content of the user. In another example, the neural network application 114 may use previously-detected user reactions to perform additional training on the neural network models 102 (e.g., in a feedback loop).

In some other aspects, the neural network application 114 may provide the updated neural network models to the deep learning environment 101 to further refine the deep learning architecture. In this manner, the deep learning environment 101 may further refine its neural network models 102 based on the sensor data captured by the media device 110 (e.g., combined with sensor data captured by various other media devices) without receiving or having access to the raw sensor data.

The media playback interface 116 may provide an interface through which the user can operate, interact with, or otherwise use the media device 110. In some embodiments, the media playback interface 116 may enable a user to browse a content library stored on (or accessible by) the media device 110 based, at least in part, on the user reactions detected by the neural network application 114. In some aspects, the media playback interface 116 may display recommendations to a user of the media device 100 based on the user's reactions to certain types or genres of media content. In some other aspects, the media playback interface 116 may display recommendations to a group of users based on individual user reactions (e.g., of individuals in the group) to certain types or genres of media content.

In some other embodiments, the media playback interface 116 may process the user reactions as user inputs to control the playback of media content by the media device 110. In some aspects, the user reactions may be used as a voting method for live or interactive content. In some other aspects, the user reactions may be used to navigate or present dynamic media content. Still further, in some aspects, the user reactions may be used to dynamically control interruptions in the playback of the content item. In some embodiments, the media playback interface 116 may provide feedback to a content creator or provider (e.g., television network, production studio, streaming service, and the like) based on the user's reactions to content they created.

Accordingly, the media device 110 provide a user (or group of users) with more targeted recommendations based on each individual user's to particular types or genres of media content. The media device 110 may also provide an improved viewing experience, for example, by allowing the user to dynamically control or interact with live or interactive media content without having to provide any additional (manual) inputs. Furthermore, by sending feedback to the content creators and/or providers indicative of actual user reactions, the media device 110 may help facilitate the creation of media content that is more custom-tailored to the tastes and preferences of its target audience.

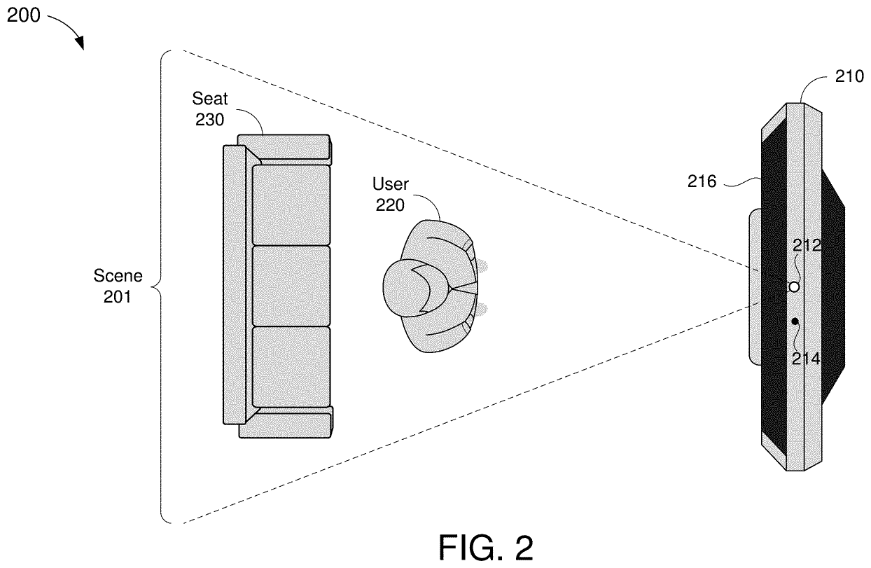

FIG. 2 shows an example environment in which the present embodiments may be implemented. The environment 200 includes a media device 210, a user 220, and a seat 230. The media device 210 may be an example embodiment of the media device 110 of FIG. 1. In the example of FIG. 2, the media device 210 is depicted as a television or display device having an integrated camera 212, microphone 214, and display 216. However, in actual implementations, the camera 212, microphone 214, and/or display 216 may be separate from the media device 210. For example, the media device 210 may be a set-top box coupled to a display, camera, and/or microphone.

The camera 212 may be an example embodiment of one or more of the sensors 112 of FIG. 1. More specifically, the camera 212 may be configured to capture images (e.g., still-frame images and/or video) of a scene 201 in front of the media device 210. For example, the camera 212 may comprise one or more optical sensors (e.g., photodiodes, CMOS image sensor arrays, CCD arrays, and/or any other sensors capable of detecting wavelengths of light in the visible spectrum, the infrared spectrum, and/or the ultraviolet spectrum).

The microphone 214 may be an example embodiment of one or more of the sensors 112 of FIG. 1. More specifically, the microphone 214 may be configured to record audio from the scene 201 (e.g., including vocalizations from the user 220 and/or other users not present in the scene 201). For example, the microphone 214 may comprise one or more transducers that convert sound waves into electrical signals (e.g., including omnidirectional, unidirectional, or bi-directional microphones and/or microphone arrays).

The display 216 may be configured to display or present media content to the user 220. For example, the display 216 may include a screen or panel (e.g., comprising LED, OLED, CRT, LCD, EL, plasma, or other display technology) upon which the media content may be rendered and/or projected. In some embodiments, the display 216 may also correspond to and/or provide a user interface (e.g., the media playback interface 116 of FIG. 1) through which the user 220 may interact with or use the media device 210.

In some embodiments, the media device 210 may monitor and/or gauge user reaction to media content presented on the display 216 based, at least in part, on sensor data acquired by the camera 212 and/or microphone 214. For example, the media device 210 may infer a reaction or engagement level of the user 220 based on visual cues (e.g., from the camera 212), audio cues (e.g., from the microphone 214), and/or other biometric cues (e.g., from other biometric sensors, not shown for simplicity) about the user. It is noted that, in some aspects, the camera 212 and microphone 214 may continuously (or periodically) capture images and audio recordings of the scene 201 without any additional input by the user 220. Accordingly, the media device 210 may detect the presence of the user 220 in response to the user 220 moving into the field of view of the camera 212 and/or speaking within audible range of the microphone 214.

Upon detecting the presence of the user 220 in the scene 201, the media device 210 may generate one or more inferences about the user's emotion and/or engagement level based, at least in part, on the image and/or audio data. More specifically, the media device 210 may gauge the user's reactions to certain types or genres of media content being presented on the display 216. For example, when playing back a particular content item, the media device 210 may infer, from the user's gaze, posture, facial expressions, and/or vocalizations, whether the user is interested or engaged in the particular content item. The media device 210 may also detect the user's reactions at a finer granularity based, at least in part, on specific image and/or audio data coinciding with specific scenes or portions of media content. For example, the media device 210 may determine, on a scene-by-scene basis, whether the user is interested or engaged in each scene of the content item (e.g., based on the sensor data captured during, or immediately after, that scene).

The media device 210 may then use the inferences about the user's reactions to provide the user 220 with a more customized user experience. In some embodiments, the media device 210 may enable the user 220 to browse a content library stored on (or accessible by) the media device 210 based, at least in part, on the user's reactions to certain types or genres of media content. For example, the media device 210 may display recommendations to the user 220 (or group of users) based, at least in part, on the types or genres of media content that elicited positive reactions (e.g., where the inferences indicated that the user 220 was interested or engaged) and/or negative reactions (e.g., where the inferences indicated that the user 220 was disinterested or disengaged).

In some other embodiments, the media device 210 may process the user's reactions as user inputs to control the playback of media content. For example, the user's reactions may be used as a voting method for live or interactive content (e.g., where the media device 210 helps to select the winner of a competition based on the user's reactions to individual contestants) and/or as a method of selection to navigate or present dynamic media content (e.g., where the media device 210 dynamically selects which storylines and/or scenes to present on the display 216 based on the user's reactions to other scenes). Still further, in some embodiments, the media device 210 may provide feedback to content creators or providers based on the user's reactions to content they created. For example, the content creators may use the feedback as a creative tool to tailor their content for their intended audience.

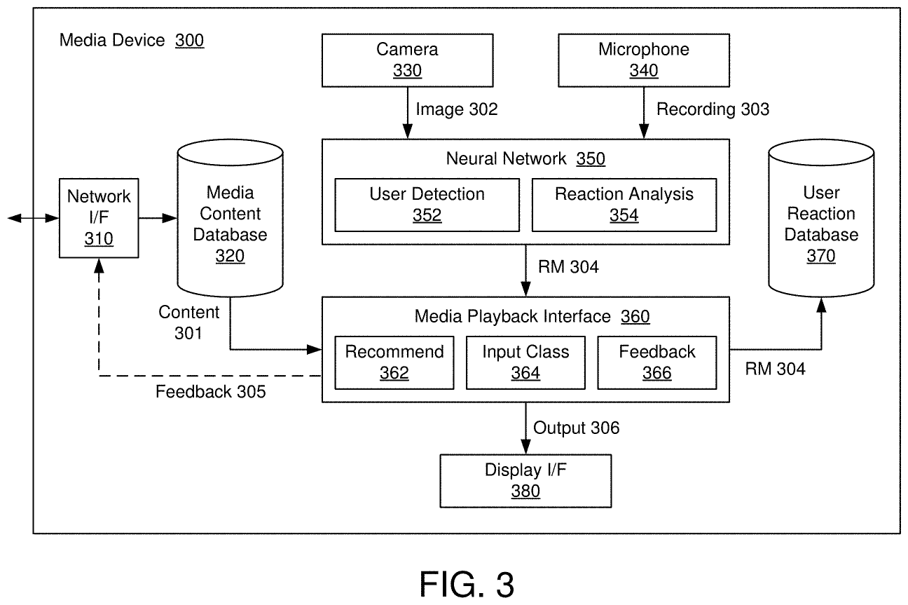

FIG. 3 shows a block diagram of a media device 300, in accordance with some embodiments. The media device 300 may be an example embodiment of the media device 110 of FIG. 1 and/or media device 210 of FIG. 2. The media device 300 includes a network interface (I/F) 310, a media content database 320, a camera 330, a microphone 240, a neural network 350, a media playback interface 360, a user reaction database 370, and a display interface 380.

The network interface 310 is configured to receive media content items 301 from one or more content delivery networks. In some aspects, the content items 301 may include audio and/or video associated with live, interactive, or pre-recorded media content (e.g., movies, television shows, video games, music, and the like). The received content items 301 may be stored or buffered in the media content database 320. In some embodiments, the media content database 320 may store or buffer the content items 301 for subsequent (or immediate) playback. For example, in some aspects, the content database 320 may operate as a decoded video frame buffer that stores or buffers the (decoded) pixel data associated with the content items 301 to be rendered or displayed by the media device 300 or a display coupled to the media device 300 (not shown for simplicity).

The camera 330 is configured to capture one or more images 302 of the environment surrounding the media device 300. The camera 330 may be an example embodiment of the camera 212 of FIG. 2 and/or one of the sensors 112 of FIG. 1. Thus, the camera 330 may be configured to capture images 302 (e.g., still-frame images and/or video) of a scene in front of, or proximate, the media device 300. For example, the camera 330 may comprise one or more optical sensors (e.g., photodiodes, CMOS image sensor arrays, CCD arrays, and/or any other sensors capable of detecting wavelengths of light in the visible spectrum, the infrared spectrum, and/or the ultraviolet spectrum).

The microphone 340 is configured to capture one or more audio recordings 303 from the environment surrounding the media device 300. The microphone 340 may be an example embodiment of the microphone 214 and/or one of the sensors 112 of FIG. 1. Thus, the microphone 340 may be configured to record audio from the scene in front of, or proximate, the media device 300. For example, the microphone 340 may comprise one or more transducers that convert sound waves into electrical signals (e.g., including omnidirectional, unidirectional, or bi-directional microphones and/or microphone arrays).

The neural network 350 is configured to generate one or more inferences about a user's reaction or engagement level based, at least in part, on the images 302 and/or audio recordings 303. For example, the neural network 350 may be an embodiment of the neural network application 114 of FIG. 1. Thus, the neural network 350 may generate inferences about user reaction or engagement using one or more neural network models stored on the media device 300. For example, as described with respect to FIG. 1, the neural network 350 may receive trained neural network models (e.g., from the deep learning environment 101) prior to receiving the images 302 and audio recordings 303. In some embodiments, the neural network 350 may include a user detection module 352 and a reaction analysis module 354.

The user detection module 352 may detect one or more users or operators of the media device 300 based, at least in part, on the images 302 and/or audio recordings 303. For example, the user detection module 352 may detect the one or more users using any known face or voice detection algorithms and/or techniques (e.g., using one or more neural network models). In some aspects, the user detection module 352 may identify a demographic of the user (or group of users) viewing the media content. For example, the user detection module 352 may detect one or more age- or gender-based cues in the images 302 and/or audio recordings 303 (e.g., using one or more neural network models).

The reaction analysis module 354 may monitor the reactions and/or engagement level of each detected user based, at least in part, on the images 302 and/or audio recordings 303. For example, the reaction analysis module 354 may implement one or more neural network models to generate inferences about the user's reactions and/or engagement level based, at least in part, on the user's gaze, posture, facial expressions, and/or vocalizations (e.g., as determined from the images 302 and/or audio recordings 303). In some aspects, the reaction analysis module 354 may use one or more scene markers (e.g., known information about the contents and/or boundaries of each scene) to fine-tune the reaction analysis. For example, the reaction analysis module 354 may look for a specific type of user reaction (e.g., happiness or laughter) depending on the type of content included in the scene (e.g., a joke or comedic elements). The reaction analysis module 354 may also use the scene markers to determine when to assess the user's reaction (e.g., before, during, and/or after playback of a particular scene).

It is noted that the sensor data used to generate inferences about user reaction have been described in the context of images 302 and audio recordings 303 for example purposes only. In actual implementations, the neural network 350 may be configured to generate inferences about the user's reaction and/or level of engagement based on any combination of sensor data. For example, the neural network 350 may detect a user's seating position and/or posture based on a setting or configuration of the user's seat (e.g., upright or reclined). As described above, an upright seating position may suggest a greater level of user engagement whereas a reclined seating position may suggest a lower level of user engagement. The neural network 350 may also detect a user's heart rate from a fitness tracker or heart rate monitor worn by the user. As described above, an elevated (or varying) heart rate may suggest a greater level of user engagement whereas a lower (or steady) heart rate may suggest a lower level of user engagement.

In some embodiments, the neural network 350 may generate a reaction map (RM) 304 for the current content item 301 being displayed by the media device 300. The reaction map 304 may indicate real-time reactions of one or more users viewing the current content item 201. In some aspects, the reaction map 304 may include an emotional label identifying a particular emotion (e.g., joy, sadness, shock, excitement, etc.) each user is experiencing at a given time. For example, the reaction map 304 for a user watching a horror scene may indicate that the user is showing signs of shock if the neural network 350 identifies one or more of the following signs: frightened facial expression, screaming, jumping out of seat, fixating gaze on display screen, and the like.

In some other aspects, the reaction map 304 may include an engagement level indicating a degree to which each user is engaged or interested in the current media content (e.g., a scale from 1 to 10 or other metric). For example, the reaction map 304 for a user watching a romantic comedy may indicate that the user is showing little interest or engagement if the neural network 350 identifies one or more of the following signs: dull facial expression, looking at phone, conversing with other people, averting gaze away from the display screen, walking away from the scene, and the like.

In some embodiments, the reaction map 304 may be provided to the media playback interface 360. The media playback interface 360 is configured to render the content items 301 for display while providing a user interface through which the user may control, navigate, or otherwise manipulate playback of the content items 301 based, at least in part, on the reaction maps 304. For example, the media playback interface 360 may generate an interactive output 306 based on the content items 301 and reaction maps 304. The output 306 may be displayed, via the display interface 380, on a display (not shown for simplicity) coupled to or provided on the media device 300. In some aspects, the output 306 may include at least a portion of a content item 301 selected for playback. More specifically, the portion of the content item 301 included in the output 306 may be dynamically selected and/or updated based, at least in part, on the reaction maps 304.

In some embodiments, the media playback interface 360 may store or buffer the reaction maps 304 in the user reaction database 370. In some aspects, the user reaction database 370 may be categorized or indexed based on the content items 301 stored in the media content database 320. For example, each layer of the user reaction database 370 may store the reaction map 304 for a different content item 301 stored in the media content database 320. In some other embodiments, the user reaction database 370 may be included in (or part of) the media content database 320. For example, the reaction maps 304 may be stored in association with the content items 301 from which they are derived.

The media playback interface 360 may include a recommendation module 362, an input classification module 364, and a feedback module 366. The recommendation module 362 may recommend media content for a user (or group of users) of the media device 300 based, at least in part on the reaction maps 304 stored in the user reaction database 370. In some aspects, the recommendation module 362 may display recommendations to a user of the media device 300 based on the user's past reactions to certain types or genres of media content. For example, if the user reacted positively (e.g., engaged, interested, excited, or other expression of “like”) towards previously-viewed action movies, the recommendation module 362 may recommend other action movies to the user. On the other hand, if the user reacted negatively (e.g., disengaged, disinterested, or disgusted, or other expression of “dislike”) towards previously-viewed action movies, the recommendation module 362 may exclude action movies from the list of recommendations to the user.

In some other aspects, the recommendation module 362 may display recommendations to a group of users based on each individual user's past reactions to certain types or genres of media content. For example, if each user in the group reacted positively (e.g., engaged, interested, excited, or other expression of “like”) towards previously-viewed romantic comedies, the recommendation module 362 may recommend other romantic comedies to the group of users. On the other hand, if at least one (or a threshold number) of the users in the group reacted negatively (e.g., disengaged, disinterested, or disgusted, or other expression of “dislike”) towards previously-viewed romantic comedies, the recommendation module 362 may exclude romantic comedies from the list of recommendations to the group.

The input classification module 364 may use the reaction maps 304 to generate user inputs to control the playback of media content by the media device 300. In some aspects, the user reactions may be used as a voting method for live or interactive content. For example, the input classification module 364 may monitor user reactions to a competitive event (e.g., singing competition, talent show, athletic contest, and the like) and determine a winner of the competition based, at least in part, on the user reactions. In some other aspects, the user reactions may be used to navigate or present dynamic media content. For example, certain forms of media content may be created with various storylines and/or alternative scenes. Thus, the input classification module 364 may dynamically select which storylines and/or scenes to present to the user based, at least in part, on the user's reactions to other scenes. Still further, in some aspects, the user reactions may be used to dynamically control interruptions in the playback of the content item 301. For example, the input classification module 364 may refrain from inserting advertisements into the timeline of the content item 301 during periods in which the user is highly engaged.

The feedback module 366 may provide feedback 305 to a content creator or provider (e.g., television network, production studio, streaming service, advertisers, and the like) based on the user's reactions to content they created. The content creators may use the feedback 305 as a creative tool to gauge which elements, characteristics, or portions of the media content were effective (e.g., engaging or elicited the desired user reaction) and/or ineffective (e.g., not engaging or elicited an undesired user reaction). For example, a comedian may use the feedback from a comedy sketch to determine which jokes were a hit with the audience and which jokes fell flat. As another example, an advertiser may use the feedback from its advertisements to determine which types of advertisements (or elements within an advertisement) are most effective at engaging a particular audience (e.g., based on age group, demographic, or genre of media content). The content creators may further use the feedback 305 to adjust or modify their media content (including targeted advertisements and live and recorded performances) to better suit the tastes and preferences of its viewers and/or live audience members.

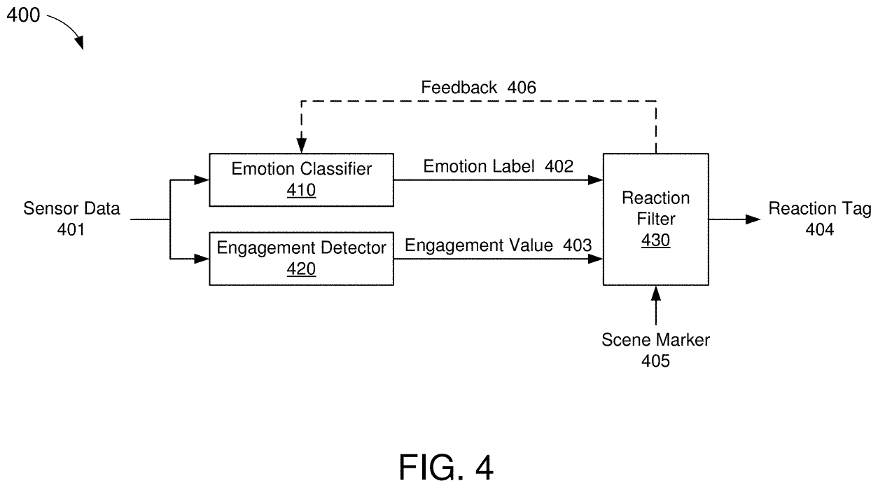

FIG. 4 shows a block diagram of a reaction detection circuit 400, in accordance with some embodiments. The reaction detection circuit 400 may be an example embodiment of the neural network 350 of FIG. 3. Accordingly, the reaction detection circuit 400 may generate inferences about one or more user's reactions to media content played back on a corresponding media device. In some embodiments, the reaction detection circuit 400 may generate a reaction tag 404 based on one or more frames of sensor data 401. The reaction detection circuit 400 includes an emotion classifier 410, an engagement detector 420, and a reaction filter 430.

The emotion classifier 410 receives one or more frames of sensor data 401 from one or more sensors of (or coupled to) the media device and generates one or more emotion labels 402, associated with pre-identified emotions, for each frame. Example sensor data 401 may include (but is not limited to): images, audio recordings, and/or other biometric information that may be collected about a user of the media device. Each emotion label 402 may describe a current emotion detected in the user (e.g., shock, horror, sadness, joy, excitement, and the like) based on the sensor data 401 (e.g., facial expression, vocalization, heart rate, etc.). As described above, the emotion classifier 410 may implement one or more neural network models that are trained to detect one or more pre-defined human emotions.

The engagement detector 420 also receives one or more frames of the sensor data 401 and generates one or more engagement values 403 corresponding to a quantized representation of the user's engagement level. In some aspects, the emotion classifier 410 and engagement detector 420 may receive the same sensor data 401. In some other aspects, the emotion classifier 410 and the engagement detector 420 may receive different sensor data 401. For example, seat sensor data or seat position information may be useful in assessing the user's engagement level (e.g., whether the user is sitting upright or reclined), but may be of little use in assessing the user's emotional state. Each engagement value 403 may describe a measure of the user's current level of engagement or interest (e.g., a scale from 1 to 10 or other metric) based on the sensor data 401 (e.g., facial expression, vocalization, heart rate, seating position, posture, etc.). As described above, the engagement detector 420 may implement one or more neural network models that are trained to detect and quantify one or more levels of user engagement.

The reaction filter 430 may aggregate the emotion labels 402 and engagement values 403 over a threshold period or duration to create one or more reaction tags 404. It is noted that a user's reaction may span multiple frames of sensor data. For example, a user's facial expression may gradually change over a given duration (e.g., from happy, to horrified, to sad). While the user's emotional state and/or engagement level may be detected with the greatest accuracy or probability at a particular frame or instance of time (e.g., coinciding with the peak of the user's reaction), the user may maintain that state of emotion and/or engagement for the duration of several frames. Thus, in some aspects, the reaction filter 430 may generate a running average of the emotion labels 402 and engagement values 403 over a predetermined number (K) of frames. Accordingly, the reaction tag 404 may indicate an average or overall emotion and/or engagement of the user over K frames.

In some embodiments, the reaction tag 404 may indicate whether the user likes or dislikes the media content currently playing back on the media device based, at least in part, on the emotion labels 402 and/or engagement values 403. For example, if the emotion label 402 indicates an expression of happiness or excitement and/or the engagement value 403 indicates a fairly high level of engagement, the reaction tag 404 may correspondingly indicate that the user likes the current media content. On the other hand, if the emotion label 402 indicates an expression of disgust or contempt and/or the engagement value 403 indicates a fairly low level of engagement, the reaction tag 404 may correspondingly indicate that the user dislikes the current media content.

In some other embodiments, the reaction filter 430 may use additional information about the media content to fine-tune the reaction tags 404. In some aspects, the reaction filter 430 may use scene markers 405 to determine when to assess the user's reaction. For example, the scene markers 405 may indicate the boundaries (e.g., starting and ending frames) of each scene. Moreover, as described above, a user's facial expression may gradually change over a given duration (particularly at the boundaries of different scenes). Thus, the reaction filter 430 may selectively begin aggregating the emotion labels 402 and engagement values 403 before, during, and/or after playback of a particular scene. For example, certain emotions are more accurately detected at the end of a scene (e.g., laughter is typically exhibited only after the telling of a joke), whereas other emotions are more accurately detected during the scene itself (e.g., excitement is typically exhibited while an action sequence plays out).

In some other aspects, the reaction filter 430 may use the scene markers 405 to further refine the detected emotion and/or engagement level. For example, the scene markers 405 may include known information about the contents (e.g., genre, style, or elements) of each scene. The reaction filter 430 may thus determine a target emotion and/or engagement level for a given scene based on the scene markers 405 and may introduce additional bias for the target emotion and/or engagement level. For example, if the user's current emotion has a relatively equal probability of being classified as either happy or sad, and the scene marker 405 indicates that the current scene is a comedy scene, the reaction filter 430 may classify the user's reaction as happy (e.g., in the corresponding reaction tag 404) based, at least in part, on the scene marker 405.

In some other embodiments, the reaction detection circuit 400 may use the scene markers 405 to perform additional training on (e.g., fine-tune) its neural network models. For example, if the scene marker 405 indicates that the current scene is of a particular genre (e.g., comedy), the reaction filter 430 may expect the user to exhibit a particular type of emotion (e.g., joy, happiness, laughter, etc.) in response to viewing the scene. Accordingly, the reaction filter 430 may provide feedback 406 to the emotion classifier 410 indicating (or affirming) the user emotion associated with this scene. In some aspects, the reaction filter 430 may provide the feedback 406 to the emotion classifier 410 only when the engagement value 403 indicates a relatively high level of user engagement (e.g., above a threshold value). Upon receiving the feedback 406, the emotion classifier 410 may perform additional training on its neural network models, using the sensor data 401 associated with that scene, to refine its ability to detect the corresponding emotion (e.g., joy, happiness, laughter, etc.) in that particular user.

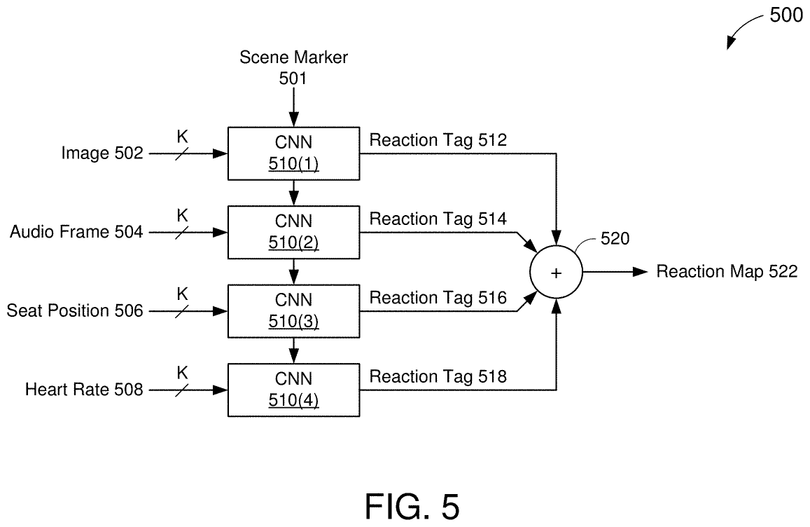

FIG. 5 shows an example neural network architecture 500 that can be used for generating inferences about user reaction, in accordance with some embodiments. The neural network architecture 500 may be an example embodiment of the neural network 350 of FIG. 3. Accordingly, the neural network architecture 500 may generate one or more inferences about a user's reaction while viewing media content displayed on a corresponding media device. In some embodiments, the neural network architecture 500 may generate a reaction map 522 based on one or more frames of sensor data. The neural network architecture 500 includes a plurality of convolutional neural networks (CNNs) 510(1)-510(4) and an aggregator 520.

The CNNs 510(1)-510(4) are configured to infer user reactions associated with a number (K) of frames of media content. For example, each of the CNNs 510(1)-510(4) may be an example embodiment of the reaction detection circuit 400 of FIG. 4. Thus, each of the CNNs 510(1)-510(4) may generate a respective reaction tag 512-518 based on a different type of sensor data 502-508 acquired during the K frames. In the example of FIG. 5, the neural network architecture 500 is shown to produce a reaction map 522 based on four different types of sensor data 502-508. However, in actual implementations the neural network architecture 500 may generate the reaction map 522 based on any number of sensor data. For example, the neural network architecture 500 may include fewer or more CNNs than those depicted in FIG. 5. As described with respect to FIG. 4, one or more of the CNNs 510(1)-510(4) may be configured to fine-tune its respective reaction tag using scene markers 501 provided with the media content.

The first CNN 510(1) may generate a first reaction tag 512 based on a number (K) of images 502 captured of a scene in front of (or proximate) the media device. The images 502 may include images of a user captured by a camera that is part of, or coupled to, the media device. The second CNN 510(2) may generate a second reaction tag 514 based on a number (K) of audio frames 504 captured from the scene in front of (or proximate) the media device. The audio frames 404 may include audio recordings of a user captured by a microphone that is part of, or coupled to, the media device. The third CNN 510(3) may generate a third reaction tag 516 based on the user's seat position 506 over a duration of the K frames. The seat position information 506 may indicate the user's body position or posture (e.g., upright or reclined) based on sensor or configuration data provided by the user's seat. The fourth CNN 510(4) may generate a fourth reaction tag 518 based on the user's heart rate 508 over a duration of the K frames. The heart rate information 508 may be provided by one or more biometric sensors (e.g., fitness tracker, heart rate monitor, and the like) worn by the user.

As described with respect to FIG. 4, each of the reaction tags 512-518 may identify one or more user reactions (e.g., emotions and/or engagement levels) that can be associated with the K frames of media content. It is noted, however, that different reaction tags 512-518 may indicate different user reactions for the K frames. For example, the first CNN 510(1) may determine that a given set of K frames is most likely associated with a relatively high level of engagement (e.g., based on the images 502) while the second CNN 510(2) may determine that the same set of K frames is most likely associated with a relatively low level of engagement (e.g., based on the audio frames 504). In some embodiments, the aggregator 520 may generate the reaction map 522 based on a combination of the reaction tags 512-518 output by the different CNNs 510(1)-510(4).

In some aspects, the aggregator 520 may select the highest-probability reaction, among the reaction tags 512-518, to be included in the reaction map 522. For example, if the first and third CNNs 510(1) and 510(3) determine that a given set of K frames is most likely associated with a relatively high level of engagement (e.g., based on the images 502 and the user's seat position 506), the second CNN 510(2) determines that the given set of K frames is most likely associated with a relatively low level of engagement (e.g., based on the audio frames 504), and the fourth CNN 510(4) determines that the given set of K frames is most likely associated with a very high level of engagement (e.g., based on the user's heart rate 508), the reaction map 522 may indicate that the given set of K frames is associated with a relatively high level of engagement.

In some other aspects, the aggregator 520 may apply different weights to different reaction tags 512-518. For example, the images 502 and audio frames 504 may provide a better indication of the user's emotion than engagement level, whereas seat position 506 and heart rate 508 may provide a better indication of the user's engagement level than emotion. Thus, when generating the reaction map 522, the aggregator 520 may weigh the emotion information included in the reaction tags 512 and 514 more heavily than the emotion information included in the reaction tags 516 and 518. Similarly, when generating the reaction map 522, the aggregator 520 may weigh the engagement information included in the reaction tags 516 and 518 more heavily than the engagement information included in the reaction tags 512 and 514.

FIG. 5 depicts an example neural network architecture 500 in which the reaction map 522 is generated by aggregating individual reaction tags 512-518 produced by respective CNNs 510(1)-510(4). However, other neural network architectures are also contemplated without deviating from the scope of this disclosure. For example, in some other implementations, each of the CNNs 510(1)-510(4) may be configured to detect one or more features (e.g., indicative of the user's emotion and/or level of engagement) based on the respective data inputs 502-508. The outputs (e.g., features) of each of the CNNs 510(1)-410(4) may be provided as inputs to another neural network which generates the reaction map 522 based on the combination of features. Still further, in some implementations, the reaction map 522 may be generated by a single neural network that receives the raw data 502-508 as its inputs. For example, the feature detection and/or reaction tagging may be performed by one or more intermediate layers of the neural network.

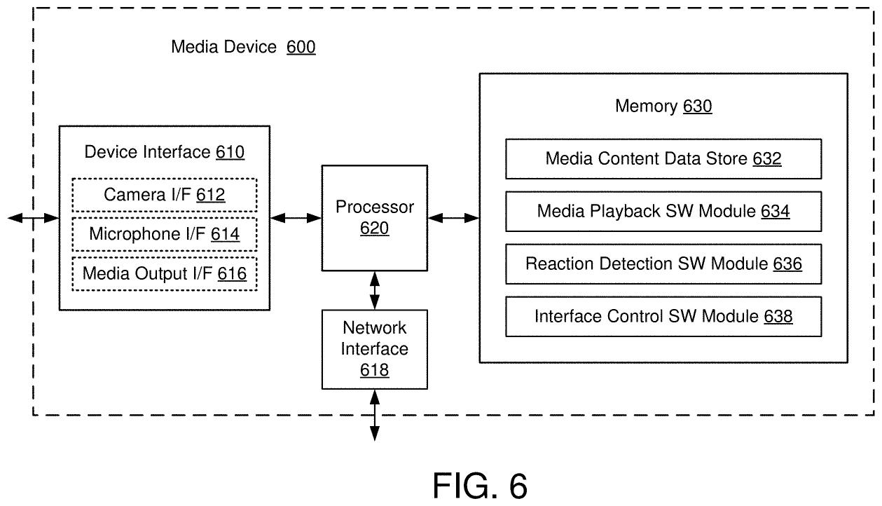

FIG. 6 shows another block diagram of a media device 600, in accordance with some embodiments. The media device 600 may be an example embodiment of the media device 110 and/or media device 200 described above with respect to FIGS. 1 and 2, respectively. The media device 600 includes a device interface 610, a network interface 612, a processor 620, and a memory 630.

The device interface 610 may include a camera interface 612, a microphone interface 614, and a media output interface 616. The camera interface 612 may be used to communicate with a camera of the media device 600 (e.g., camera 212 of FIG. 2 and/or camera 330 of FIG. 3). For example, the camera interface 612 may transmit signals to, and receive signals from, the camera to capture an image of a scene facing the media device 600. The microphone interface 614 may be used to communicate with a microphone of the media device 600 (e.g., microphone 214 of FIG. 2 and/or microphone 340 of FIG. 3). For example, the microphone interface 614 may transmit signals to, and receive signals from, the microphone to record audio from the scene.

The media output interface 616 may be used to communicate with one or more media output components of the media device 600. For example, the media output interface 616 may transmit information and/or media content to a display device. The network interface 618 may be used to communicate with a network resource external to the media device 600 (e.g., the content delivery networks 120 of FIG. 1). For example, the network interface 618 may receive media content from the network resource.

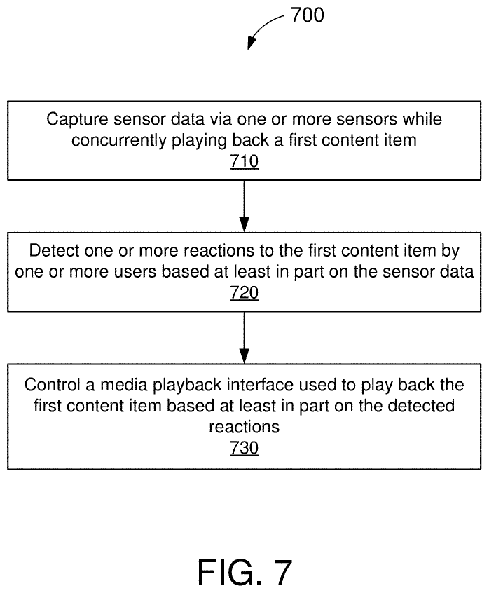

The memory 630 includes a media content data store 632 to store media content received via the network interface 612. For example, the media content data store 632 may buffer a received content item for playback by the media device 600. The memory 630 may also include a non-transitory computer-readable medium (e.g., one or more nonvolatile memory elements, such as EPROM, EEPROM, Flash memory, a hard drive, etc.) that may store at least the following software (SW) modules:
a media playback SW module 634 to play back a content item via the media device 600;
a reaction detection SW module 636 to detect one or more reactions to the content item by one or more users based at least in part on sensor data acquired while concurrently playing back the content item; and
an interface control SW module 638 to control a media playback interface used to play back the first content item based at least in part on the detected reactions.
   Each software module includes instructions that, when executed by the processor 620, cause the media device 600 to perform the corresponding functions. The non-transitory computer-readable medium of memory 630 thus includes instructions for performing all or a portion of the operations described below with respect to FIG. 7.

Processor 620 may be any suitable one or more processors capable of executing scripts or instructions of one or more software programs stored in the media device 600. For example, the processor 620 may execute the media playback SW module 634 to play back a content item via the media device 600. The processor 620 may also execute the reaction detection SW module 636 to detect one or more reactions to the content item by one or more users based at least in part on sensor data acquired while concurrently playing back the content item. Still further, the processor 620 may execute the interface control SW module 638 to control a media playback interface used to play back the first content item based at least in part on the detected reactions.

FIG. 7 shows an illustrative flowchart depicting an example operation 700 for playing back media content, in accordance with some embodiments. The example operation 700 can be performed by a media device such as, for example, the media device 110 of FIG. 1, the media device 210 of FIG. 2, and/or the media device 300 of FIG. 3.

The media device captures sensor data via one or more sensors while concurrently playing back a first content item (710). The first content item may include audio and/or video associated with live, interactive, or pre-recorded media content (e.g., movies, television shows, video games, music, and the like). In some embodiments, the sensor data may be acquired via a camera configured to capture images (e.g., still-frame images and/or video) of a scene in front of the media device. In some other embodiments, the sensor data may be acquired via a microphone configured to record audio from the scene (e.g., including vocalizations from the user and/or other users not present in the scene).

The media device detects one or more reactions to the first content item by one or more users based at least in part on the sensor data (720). For example, the media device may infer a reaction or engagement level of the user based on visual cues (e.g., from the camera), audio cues (e.g., from the microphone), and/or other biometric cues about the user. More specifically, the media device may gauge the user's reactions to certain types or genres of media content being presented on the display. For example, when playing back a particular content item, the media device may infer, from the user's gaze, posture, facial expressions, and/or vocalizations, whether the user is interested or engaged in the particular content item. The media device may also detect the user's reactions at a finer granularity based, at least in part, on specific image and/or audio data coinciding with specific scenes or portions of media content. For example, the media device may determine, on a scene-by-scene basis, whether the user is interested or engaged in each scene of the content item (e.g., based on the sensor data captured during, or immediately after, that scene).

The media device controls a media playback interface used to play back the first content item based at least in part on the detected reactions (730). For example, the media device may use the inferences about the user's reactions to provide a more customized user experience. In some embodiments, the media device may enable the user to browse a content library stored on (or accessible by) the media device based, at least in part, on the user's reactions to certain types or genres of media content. In some other embodiments, the media device may process the user's reactions as user inputs to control the playback of media content. Still further, in some embodiments, the media device may provide feedback to content creators or providers based on the user's reactions to content they created.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, embodiments have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method of playing back media content, comprising:
capturing sensor data via one or more sensors while concurrently playing back a first content item;
detecting one or more reactions to the first content item by one or more users based at least in part on the sensor data; and
controlling a media playback interface used to play back the first content item based at least in part on the detected reactions.

2. The method of claim 1, wherein the detecting comprises:
inferring an emotion of at least one of the one or more users using a neural network model.

3. The method of claim 1, wherein the detecting comprises:
inferring an engagement level of at least one of the one or more users using a neural network model.

4. The method of claim 1, wherein the detecting comprises:
identifying a plurality of scenes in the first content item, wherein at least one of the one or more reactions is detected for each of the plurality of scenes.

5. The method of claim 1, wherein the sensor data includes at least one of an image or audio recording of the one or more users.

6. The method of claim 1, wherein the controlling comprises:
recommending additional content items for at least one of the one or more users based at least in part on the detected reactions.

7. The method of claim 1, further comprising:
providing feedback to a creator of the first content item based at least in part on the detected reactions.

8. The method of claim 1, wherein the controlling comprises:
classifying the detected reactions as one or more user inputs.

9. The method of claim 8, wherein the controlling further comprises:
dynamically presenting media content during the playback of the first content item based on the one or more user inputs.

10. The method of claim 9, wherein the media content comprises one or more advertisements.

11. The method of claim 9, wherein the media content comprises one or more alternative scenes of the first content item.

12. A media device, comprising:
processing circuitry; and
memory storing instructions that, when executed by the processing circuitry, cause the media device to:
capture sensor data via one or more sensors while concurrently playing back a first content item;
detect one or more reactions to the first content item by one or more users based at least in part on the sensor data; and
control a media playback interface used to play back the first content item based at least in part on the detected reactions.

13. The media device of claim 12, wherein execution of the instructions for detecting the one or more reactions causes the media device to:
infer an emotion of at least one of the one or more users using a neural network model.

14. The media device of claim 12, wherein execution of the instructions for detecting the one or more reactions causes the media device to:
infer an engagement level of at least one of the one or more users using a neural network model.

15. The media device of claim 12, wherein execution of the instructions for detecting the one or more reactions causes the media device to:
identify a plurality of scenes in the first content item, wherein at least one of the one or more reactions is detected for each of the plurality of scenes.

16. The media device of claim 12, wherein the sensor data includes at least one of an image or audio recording of the one or more users.

17. The media device of claim 12, wherein execution of the instructions for controlling the media playback interface causes the media device to:
recommend additional content items for at least one of the one or more users based at least in part on the detected reactions.

18. The media device of claim 12, wherein execution of the instructions further causes the media device to:
provide feedback to a creator of the first content item based at least in part on the detected reactions.

19. The media device of claim 12, wherein execution of the instructions for controlling the media playback interface causes the media device to:
classify the detected reactions as one or more user inputs.

20. The media device of claim 19, wherein execution of the instructions for controlling the media playback interface further causes the media device to:
dynamically present media content during the playback of the first content item based on the one or more user inputs.
